(19) United States
(12) Patent Application Publication
(10) Pub. No.: US 2022/0186047 A1
(43) Pub. Date: Jun. 16, 2022

(54) LAMINATE FOR FROST PREVENTION, HEAT EXCHANGER INCLUDING THE LAMINATE, AND COATING AGENT FOR FROST PREVENTION

(71) Applicant: 3M INNOVATIVE PROPERTIES COMPANY, St. Paul, MN (US)

(72) Inventors: Naota Sugiyama, Kanagawa (JP); Taiki Ihara, Tokyo (JP); Wataru Nakayam, Tokyo (JP); Yusaku Yoshiike, Kanagawa (JP)

(21) Appl. No.: 17/593,359

(22) PCT Filed: Mar. 27, 2020
(86) PCT No.: PCT/IB2020/052933

§ 371 Date: Sep. 16, 2021

(30) Foreign Application Priority Data
Apr. 1, 2019 (JP) 2019-070135

(51) Int. Cl. C09D 7/61; F28F 21/04; F28F 19/00; C09D 7/40; C09D 5/00; B05D 1/28; B05D 3/06; B05D 7/00

(52) U.S. Cl. CPC C09D 7/61; F28F 21/04; F28F 19/006; C09D 7/67; B05D 2202/25; B05D 1/28; B05D 3/067; B05D 7/52; F28F 2245/02; C09D 5/002

(57) ABSTRACT

To provide a laminate for frost prevention, a heat exchanger including the laminate, and a coating agent for frost prevention, which have excellent reduction or prevention effect of frost growth. A laminate for frost prevention of an embodiment of the present embodiments including: a substrate, and a frost prevention layer containing first inorganic nanoparticles and a hydrophilic binder and exhibiting a water contact angle of 19.0 degrees or less.

### TECHNICAL FIELD

The present disclosure relates to a laminate for frost prevention, a heat exchanger including the laminate, and a coating agent for frost prevention.

### BACKGROUND ART

Techniques for suppressing frost formation by using a water-repellent layer or a layer containing a surfactant have been known.

Patent Document 1 (JP 2017-193666 A) describes a component for low temperature environments, such as a heat exchanger. The component is obtained by forming a water-slipping and water-repellent layer on a substrate, and the water-slipping and water-repellent layer is formed from a perfluoropolyether structure and a siloxane structure, and a three-dimensional skewness SRsk of a surface of the water-slipping and water-repellent layer is greater than 0.

Patent Document 2 (WO 2012/157325) describes an aqueous coating composition for suppressing frost formation on heat exchanger fins. The aqueous coating composition contains an acrylic modified epoxy resin (A), at least one type of crosslinking agent (B) selected from the group consisting of amino resins, polyisocyanates, and blocked polyisocyanates, a fluorine-based polymer (C), and an agent for imparting defoaming properties (D).

Patent Document 3 (JP 5361385 B) describes an anti-frost film assembly containing a transparent film and a transparent anti-frost layer, the anti-frost layer being formed from a polyurethane-film forming composition effective to impart anti-frost properties to the anti-frost layer at temperatures that alternate between −23° C. and 65° C., the polyurethane-film forming composition containing a surfactant having an isocyanate-reactive moiety, a hydrophobic region, and a hydrophilic region.

Patent Document 4 (JP 3274077 B) describes an aluminum or aluminum alloy component having excellent water repellency and frost-formation prevention properties, the component having a chemically treated film that is formed as a substrate treatment film on a surface of an aluminum or aluminum alloy substrate and that has a crystal water amount in the film of 10 microgram/cm² or greater, and a water-repellent film formed from a coating formed at a coating amount from 0.1 to 20 mg/dm² on the chemically treated film.

### CITATION LIST

### Patent Documents

Patent Document 1: JP 2017-193666 A

Patent Document 2: WO 2012/157325

Patent Document 3: JP 5361385 B

Patent Document 4: JP 3274077 B

### SUMMARY OF INVENTION

### Technical Problem

For example, a heat exchanger used in an electric automobile cannot utilize waste heat produced by an engine, unlike typical automobiles on which engines are mounted, the space between fins is easily clogged with frost formed and grown on the fins of the heat exchanger, which is a factor that reduces the heat exchange efficiency.

Techniques utilizing a water-repellent layer exhibit frost prevention properties by enabling a waterdrop grown to a large size to slip down. Because of this, during the growth of waterdrop or during the slipping of waterdrop, the waterdrop freezes, and frost may be grown from the waterdrop as a starting point. Techniques that utilize a surfactant-containing layer may reduce frost prevention function over time because of the surfactant bleeding.

The present disclosure provides a laminate for frost prevention, a heat exchanger including the laminate, and a coating agent for frost prevention, which have excellent reduction or prevention effect of frost growth.

### Solution to Problem

According to an embodiment of the present disclosure, a laminate for frost prevention having a substrate and a frost prevention layer containing first inorganic nanoparticles and a hydrophilic binder and exhibiting a water contact angle of 19.0 degrees or less is provided.

According to another embodiment of the present disclosure, a heat exchanger including the laminate for frost prevention described above is provided.

According to another embodiment of the present disclosure, provided is a coating agent for frost prevention containing first inorganic nanoparticles and at least one type selected from the group consisting of hydrophilic binders, hydrophilic curable monomers, and hydrophilic curable oligomers, in which a frost prevention layer formed by the coating agent for frost prevention exhibits a water contact angle of 19.0 degrees or less.

### Advantageous Effects of Invention

According to the present disclosure, a laminate for frost prevention, a heat exchanger including the laminate, and a coating agent for frost prevention, which have excellent reduction or prevention effect of frost growth can be provided.

The above descriptions should not be construed that all aspects of the present embodiment and all advantages of the present disclosure are disclosed.

### BRIEF DESCRIPTION OF DRAWINGS

FIG. 1 is observation photographs of frost formation test of the aluminum substrate of Comparative Example 1 and the laminate for frost prevention of Example 4.

FIG. 2 is observation photographs of frost thawing test of the aluminum substrate of Comparative Example 1 and the laminate for frost prevention of Example 4.

FIG. 3A is an atomic force microscopy image for a 3 μm×3 μm area region of the frost prevention layer surface of Example 4. FIG. 3B is an atomic force microscopy image for a 1 μm×1 μm area region of the frost prevention layer surface of Example 4.

FIG. 4 is a graph related to the arithmetic average surface roughness Ra of the frost prevention layer surface in Examples 1 to 4 and Comparative Example 2.

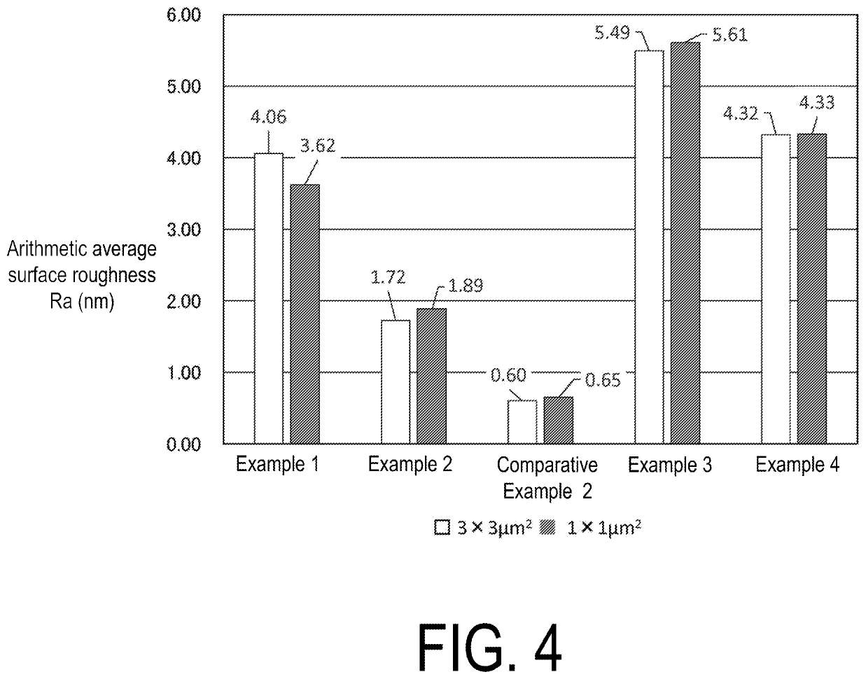

### DESCRIPTION OF EMBODIMENTS

Detailed description will be given for the purpose of exemplifying representative embodiments of the present invention, but the present invention is not limited to these embodiments.

In the present disclosure, “(meth)acrylic” means acrylic or methacrylic, and “(meth)acrylate” means acrylate or methacrylate.

In the present disclosure, “hydrophilic” means a performance that can achieve a lower water contact angle compared to a water contact angle of a substrate or that can achieve water dispersibility or water solubility.

In the present disclosure, “frost prevention” or “frost prevention properties” also mean reduction of frost formation as well as prevention of frost formation.

In the present disclosure, “frost thawing” or “frost thawing properties” mean reduction or disappearance of formed frost.

In the present disclosure, “dispersion” means a non-aggregated state, and “water dispersibility” means a state in which inorganic nanoparticles are not aggregated and not precipitated in water.

In the present disclosure, for example, “on” in “a frost prevention layer arranged on a substrate” means the frost prevention layer being directly arranged on the substrate or the frost prevention layer being indirectly arranged above the substrate through another layer.

According to an embodiment, the laminate for frost prevention includes a substrate and a frost prevention layer containing first inorganic nanoparticles and a hydrophilic binder and exhibiting a water contact angle of 19.0 degrees or less. The inventors of the present invention found that a hydrophilic layer having a particular water contact angle exhibits surprisingly frost prevention properties, and also found that a laminate including such a layer is suitably used for an application requiring frost prevention. The inventors of the present invention found that the layer has surprisingly excellent thawing properties for formed frost.

The material of the substrate is not particularly limited and, for example, an organic material, an inorganic material, or a metal material can be used. Examples of the organic material include polycarbonate, poly(meth)acrylate (e.g. polymethyl methacrylate (PMMA)), polyolefin (e.g. polyethylene (PE), polypropylene (PP)), polyurethane, polyester (e.g. polyethylene terephthalate (PET), polyethylene naphthalate (PEN)), polyamide, polyimide, phenolic resins, cellulose diacetate, cellulose triacetate, polystyrene, styrene acrylonitrile copolymers, acrylonitrile butadiene styrene copolymers (ABS), epoxy, polyacetate, and vinyl chloride. Examples of the inorganic material include glass and ceramics. Examples of the metal material include aluminum, iron, copper, and alloys thereof (e.g., stainless steel). These materials can be used alone or in combination of two or more thereof.

The shape or structure of the substrate is not particularly limited. For example, the shape may be a film shape, a plate shape, a curved shape, an irregular shape, or a three-dimensional shape, and the structure may be a monolayer structure, a laminate structure, or a composite structure in which a plurality of substrates having shapes different from each other are combined.

The substrate may be transparent or colored transparent. “Transparent” in this disclosure indicates that a total light transmittance is 80% or greater, 85% or greater, or 90% or greater. “Colored transparent” means a transparency that allows visual confirmation of a target object through a colored substrate, like sunglasses, and in this case, the total light transmittance may be 80% or less. The total light transmittance in the present disclosure means an average transmittance in a wavelength region of 400 nm to 700 nm measured at 25° C. by using a spectrophotometer in accordance with JIS K 7361-1 (1997).

The thickness of the substrate is not particularly limited, and for example, in the case of a film-like substrate, the thickness may be 5 μm or greater, 10 μm or greater, or 15 μm or greater, and less than 500 μm, 400 μm or less, or 300 μm or less. In the case of a substrate having a thickness greater than that of a film-like substrate, such as the case of a plate-like substrate, the thickness may be 0.5 mm or greater, 1 mm or greater, or 1.5 mm or greater, and 10 mm or less, 7 mm or less, or 5 mm or less.

In the frost prevention layer, from the perspective of reducing or preventing growth of frost, a water contact angle of a surface of the frost prevention layer is preferably 19.0 degrees or less, 15.0 degrees or less, or 13.0 degrees or less. With the frost prevention layer exhibiting such hydrophilicity, even when moisture is attached on a surface, the moisture spreads thin on the frost prevention layer surface, and the size of the waterdrop is less likely to be grown as in the case on a typical water-repellent layer. As a result, the frost prevention layer of the present disclosure is conceived to exhibit excellent reduction or prevention effect of frost growth.

Taking thawing properties of formed frost into consideration, the water contact angle of the frost prevention layer surface is preferably 11.0 degrees or less, 10.0 degrees or less, or 9.0 degrees or less. The lower limit of the water contact angle is not particularly limited and, for example, may be 1.0 degree or greater, 2.0 degrees or greater, or 3.0 degrees or greater.

From the perspective of frost prevention properties or frost thawing properties, the arithmetic average surface roughness Ra of the frost prevention layer surface is preferably 1.0 nm or greater, 2.0 nm or greater, 3.0 nm or greater, 3.5 nm or greater, or 4.0 nm or greater. The upper limit of the arithmetic average surface roughness Ra is not particularly limited and, for example, may be 30 nm or less, 20 nm or less, or 10 nm or less. When the roughness of the frost prevention layer surface is within the range, it is conceived that moisture attached onto the frost prevention layer surface tends to spread thinner, and thus further reduction or prevention of frost growth can be achieved. In the present embodiment, frost means ice obtained by allowing moisture in the air to touch a surface of an article and crystallize, and the ice grows in a manner that the ice protrudes from the article surface and looks white by scattering light. The formation of frost can be observed by visual inspection of the article surface before the frost formation and the article surface under frost forming environment, and can be distinguished by whiteness of the article surface.

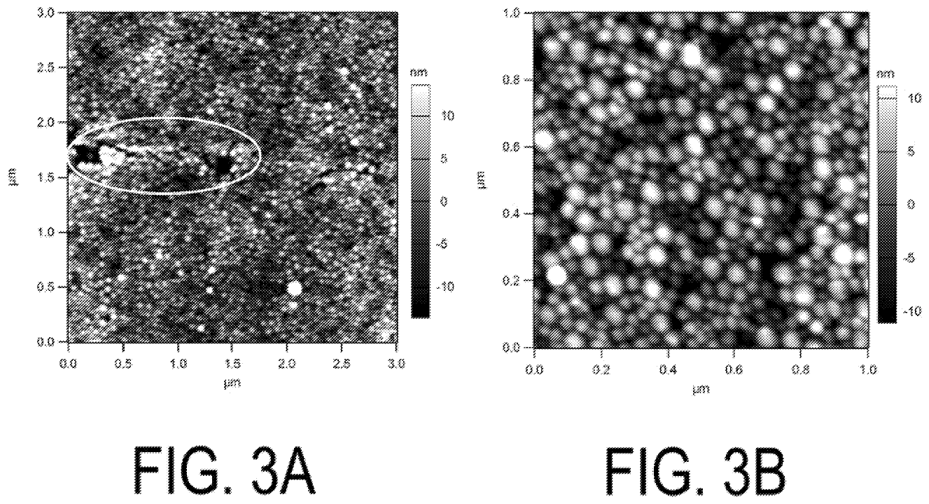

Herein, the arithmetic average surface roughness Ra of the frost prevention layer surface is in accordance with JIS B 0601, and can be defined as an average value of Ra values throughout the region, measured in a 1 μm×1 μm area region or a 3 μm×3 μm area region of the frost prevention layer surface by using an atomic force microscope (AFM). The measured part is selected from parts having a relatively uniform surface protrusions and recesses and, for example, parts in which a defected part having an obviously different shape or size compared to shape or size of the surrounding protrusions and recesses caused by an extraneous substance or coating unevenness (e.g., a white lined portion of FIG. 3A) is present are excluded.

The hydrophilic binder is not particularly limited, and examples of the hydrophilic binder include polyethylene glycols; poly-N-vinylpyrrolidones; polyvinyl acetates; hydrophilic poly(meth)acrylates, such as (meth)acrylic resins containing at least one selected from the group consisting of amphoteric ions, ethylene oxide, and propylene oxide; hydrophilic polyurethanes; and hydroxy group-containing resins. These can be used alone or in combination of two or more thereof. Such a hydrophilic binder can be prepared by a hydrophilic curable monomer and/or a hydrophilic curable oligomer and exhibits excellent water dispersibility or water solubility. For example, from the perspectives of action of exhibiting hydrophilicity and weather resistance, the binder having a hydrophilicity preferably contains no aromatics. Herein, in the case of a simple designation “curable” in the present disclosure, the “curable” includes curing performances, such as heat curability and ionizing radiation curability, and the curing performances can be properly selected based on, for example, the use and productivity. Furthermore, curing in the present disclosure also includes those typically called polymerization.

In the frost prevention layer, the hydrophilic binder can enhance frost prevention properties, frost thawing properties, scratch resistance, and/or adhesion to a substrate or a surface-treated layer (e.g., primer layer). Taking such performances into consideration, as the hydrophilic binder, use of at least one selected from the group consisting of polyethylene glycols, hydroxy group-containing resins, and (meth)acrylic resins containing at least one selected from the group consisting of amphoteric ions, ethylene oxide, and propylene oxide is preferred. As the hydroxy group-containing resin, for example, a polyvinyl alcohol, a hydroxy group-containing (meth)acrylic resin obtained from a curable (meth)acrylic monomer or oligomer, or a hydroxy group-containing polyester resin can be used.

Among these, from the perspectives of frost prevention properties, frost thawing properties, and scratch resistance, as the hydrophilic binder, a (meth)acrylic resin containing at least one selected from the group consisting of ethylene oxide and propylene oxide is preferred. Such a (meth)acrylic resin can be obtained by polymerizing a hydrophilic monomer, such as polyethylene glycol (meth)acrylate, polyethylene glycol di(meth)acrylate, polyethylene glycol tri(meth)acrylate, polypropylene glycol (meth)acrylate, polypropylene glycol di(meth)acrylate, and polypropylene glycol tri(meth)acrylate. The hydrophilic monomers can be used alone or in combination of two or more thereof. Such polyethylene glycol (meth)acrylates or polypropylene glycol (meth)acrylates can use various monomers having various chain lengths of ethylene or propylene glycol, and the hydrophilicity can be controlled by a chain length number (n). For example, as a binder having a hydrophilicity, a binder having the chain length number of 1 or greater can be used, and preferably a binder having the chain length number of 5 or greater, 7 or greater, or 10 or greater can be used. If the chain length number is too large, the coating agent may be whitened. Thus, the upper limit of the chain length number may be 500 or less.

As long as the (meth)acrylic resin is hydrophilic, among the hydrophilic monomers, for example, the (meth)acrylic resin can be obtained by using at least one selected from the group consisting of polyethylene glycol di(meth)acrylate, polyethylene glycol tri(meth)acrylate, polypropylene glycol di(meth)acrylate, polypropylene glycol tri(meth)acrylate, which are polyfunctional monomers, together with one or a combination of plurality of publicly known curable monofunctional monomers and polyfunctional monomers or oligomers, which have a hydrophilicity or no hydrophilicity.

As the monofunctional monomer, a monomer having one ethylenic double bond can be used. As such a monofunctional monomer, for example, 2-hydroxyethyl acrylate (HEA), 2-hydroxypropyl acrylate (HPA), 2-hydroxyethyl methacrylate (HEMA), styrene monomers, ethyl acrylate, and butyl acrylate can be used but the monofunctional monomer is not limited to these.

As the polyfunctional monomer or oligomer, a curable polyfunctional monomer or oligomer having a reactive bi- or higher-functional groups can be used. Examples of the polyfunctional monomer or oligomer include polyfunctional (meth)acrylate monomers, polyfunctional (meth)acrylic urethane monomers, and oligomers of these.

The polyfunctional (meth)acrylate monomer or oligomer is an organic compound having two or more (meth)acryloyloxy groups in a molecule. As the polyfunctional (meth)acrylate monomer or oligomer, for example, tricyclodecane dimethylol diacrylate, polypropylene glycol diacrylate, polyethylene glycol diacrylate, trimethylolpropane triacrylate, trimethylolpropane trimethacrylate, trimethylolpropane PO-modified triacrylate, glycerin PO adduct triacrylate, c-caprolactone-modified tris(acryloxyethyl)isocyanurate, pentaerythritol triacrylate, pentaerythritol tetraacrylate, ditrimethylolpropane tetraacrylate, dipentaerythritol pentaacrylate, dipentaerythritol hexaacrylate, dendrimer acrylate, or oligomers of these can be used but the polyfunctional (meth)acrylate monomer or oligomer is not limited to these.

The polyfunctional (meth)acrylic urethane monomer or oligomer is an organic compound having two or more (meth)acryloyloxy groups in a molecule. As the polyfunctional (meth)acrylic urethane monomer or oligomer, for example, phenylglycidyl ether acrylate hexamethylene diisocyanate urethane prepolymers, pentaerythritol triacrylate toluene diisocyanate urethane prepolymers, dipentaerythritol pentaacrylate hexamethylene diisocyanate urethane prepolymers, or oligomers of these can be used but the polyfunctional (meth)acrylic urethane monomer or oligomer is not limited to these.

In the case where a hydrophilic polyfunctional monomer or oligomer, a non-hydrophilic polyfunctional monomer or oligomer, a hydrophilic monofunctional monomer, and a non-hydrophilic monofunctional monomer are combined for use, such use is possible by proper mixing taking, for example, frost prevention properties, frost thawing properties, and scratch resistance into consideration.

The polymerization of the monomer or oligomer can be performed by, for example, thermal polymerization or photopolymerization but the polymerization is not limited to these. In the case of the thermal polymerization, a thermal polymerization initiator can be used. As the thermal polymerization initiator, for example, a hydrophilic thermal polymerization initiator can be used, such as a peroxide (e.g., potassium peroxodisulfate, ammonium peroxodisulfate) or an azo compound (e.g., VA-044, V-50, V-501, VA-057 (Wako Pure Chemical Industries, Ltd.)) can be used but the thermal polymerization initiator is not limited to these. In addition, for example, a radical initiator having a polyethylene oxide chain can also be used. As the catalyst, for example, N,N,N′,N′-tetramethylethylene diamine and β-dimethylaminopropionitrile, which are tertiary amine compounds, can be used.

The photopolymerization can be performed by, for example, using an ionizing radiation, such as electron beam and ultraviolet light. In the case where an electron beam is used, no photopolymerization initiator may be used; however, in the case of photopolymerization by ultraviolet light, a photopolymerization initiator is used. As the photopolymerization initiator, for example, a water soluble or hydrophilic photopolymerization initiator, such as Irgacure (trade name) 2959, Darocur (trade name) 1173, Darocur (trade name) 1116, and Irgacure (trade name) 184 (available from BASF), and Quantacure (trade name) ABQ, Quantacure (trade name) BT, and Quantacure (trade name) QTX (available from Shell Chemicals), can be used but the photopolymerization initiator is not limited to these.

The total amount of the hydrophilic binder contained in the frost prevention layer or the total amount of at least one type selected from the group consisting of hydrophilic binders, hydrophilic curable monomers, and hydrophilic curable oligomers contained in the coating agent for frost prevention may be 5 mass % or greater, 10 mass % or greater, or 15 mass % or greater, but 25 mass % or less, 23 mass % or less, or 20 mass % or less, relative to the total weight (dry coating amount) of the frost prevention layer or the total weight (solid content) of the coating agent for frost prevention.

Note that, in the case where the silane coupling agent described below is hydrophilic and is a silane coupling agent having, for example, a vinyl group or a (meth)acryl group, such a silane coupling agent may be considered as one type of the hydrophilic binders.

The first inorganic nanoparticles are not particularly limited as long as the frost prevention layer exhibits a predetermined water contact angle and, for example, at least one type of particles selected from the group consisting of silicas (SiO, SiO₂), alumina (Al₂O₃), titanium oxide (TiO₂), zinc oxide (ZnO), zirconium oxide (ZrO2), tin-doped indium oxide (ITO), and antimony-doped tin oxide (ATO) can be used. Among these, silica, alumina, and zirconium oxide are preferred, and silica is particularly preferred. Because the water dispersible silica nanoparticles have silanol groups on the surfaces, the silica nanoparticles can further enhance the hydrophilicity of the frost prevention layer compared to other particles.

As the first inorganic nanoparticles, a commercially available product can be used. For example, as the silica particles, NALCO (trade name) 2327 (available from Nalco) can be used; as the alumina particles, Bairaru (trade name) AL-A7 (available from Taki Chemical Co., Ltd.) can be used; as the titanium oxide particles, TTO-51(A) (available from Ishihara Sangyo Kaisha, Ltd.) can be used; as the zinc oxide particles, NANOBYK (trade name) 3820 (available from BYK) can be used; as the zirconium oxide, Bairaru (trade name) Zr-20 (available from Taki Chemical Co., Ltd.) can be used; as the tin-doped indium oxide, PI-3 (available from Mitsubishi Materials Electronic Chemicals Co., Ltd.) can be used; and as the antimony-doped tin oxide, 549541 (available from Sigma-Aldrich) can be used.

From the perspectives of hydrophilicity, frost prevention properties, frost thawing properties, and scratch resistance, the first inorganic nanoparticles are preferably particles that are unmodified and can be dispersed in water without being aggregated. As the inorganic nanoparticles, for example, particles that disperse in water only by electrostatic repulsion of particle surfaces due to pH adjustment can be used but the inorganic nanoparticles are not limited to these. Herein, “unmodified” means that a terminal group on the inorganic nanoparticle surface is not modified by a functional group and, for example, includes the state in which no treatment is performed for bonding (covalent bonding, ionic bonding, or bonding by physisorption) a surface treatment agent on inorganic nanoparticle surfaces to facilitate dispersion of the inorganic nanoparticles in water and in the coating agent for frost prevention. As the first inorganic nanoparticles, in the case where particles which are untreated with a surface treatment agent, such as a polymer, and in which the inorganic nanoparticle surfaces are exposed (unmodified state) are used, scratch resistance, hardness, and hydrophilicity of the inorganic nanoparticles can be further exhibited on the frost prevention layer surface to which the particles have been blended.

The amount of the first inorganic nanoparticles may be 75 mass % or greater, 77 mass % or greater, or 80 mass % or greater, but 95 mass % or less, 90 mass % or less, or 85 mass % or less, relative to the total weight (dry coating amount) of the frost prevention layer or the total weight (solid content) of the coating agent for frost prevention. When the inorganic nanoparticles are highly blended as described above, frost prevention properties, frost thawing properties, and scratch resistance of the resulting frost prevention layer can be enhanced, and also durability and long-lasting properties of the frost prevention or frost thawing effect can be further enhanced compared to those of a frost prevention layer that mainly uses organic materials, such as typical water-repellent layers or surfactant-containing layers.

The average particle diameter of the first inorganic nanoparticles can be measured by using a commonly used technology in the art, such as a transmission electron microscope (TEM) or a scanning electron microscope (SEM). TEM is advantageously used for measurement of an average particle diameter of the inorganic nanoparticles in a solution, such as a coating agent for frost prevention. SEM, which allows observation of a frost prevention layer cross-section, is advantageously used for measurement of an average particle diameter of the inorganic nanoparticles in a frost prevention layer constituting a laminate for frost prevention. The average particle diameter determined by these measurement methods can be defined as an average value for 10 or more particles, such as from 10 to 100 particles. As an example, the measurement method by TEM is described below.

In the measurement of the average particle diameter of the inorganic nanoparticles by TEM, a sol sample for TEM image can be prepared by adding a sol sample dropwise onto a 400-mesh copper TEM lattice having an ultra-thin carbon substrate on an upper face of a lacey carbon (available from Ted Pella Inc. (Redding, Calif.)) of the mesh. Some of the droplets can be removed by bringing them into contact with a side part or bottom part of the lattice together with a filter paper. The remainder of the sol solvent can be heated or left at room temperature to be removed. By this, an image can be created by leaving particles on an ultra-thin carbon substrate and minimizing interference of the substrate. The TEM images can be then recorded at a large number of positions all over the lattice. For example, images sufficient to enable measurement of particle diameters of 500 to 1000 particles can be recorded. The average particle diameter of the inorganic nanoparticles can be calculated based on the measured values of the particle diameters of each sample.

The TEM image can be obtained by, for example, using a high-resolution transmission electron microscope (available under the trade name “Hitachi H-9000” from Hitachi High-Technologies Corporation) that operates at 300 kV (using Lab6 source). The image may be recorded by using a camera (e.g. available under the trade name “GATAN ULTRASCAN CCD” from Gatan, Inc. (Pleasanton, CA); model number: 895; 2 k x 2 k chip). The images can be taken at magnifications of 50000 and 100000. For some samples, the image can be taken at a magnification of 300000.

In some embodiments, the average particle diameter of the first inorganic nanoparticles may be, for example, 15 nm or greater, 20 nm or greater, 30 nm or greater, or 50 nm or greater. The upper limit of the average particle diameter of the first inorganic nanoparticles is not particularly limited and, for example, may be 500 nm or less, 400 nm or less, 300 nm or less, 200 nm or less, or 100 nm or less. When first inorganic nanoparticles having such an average particle size are employed, it becomes easier to provide a predetermined hydrophilicity and surface roughness to the frost prevention layer, and as a result, frost prevention properties or frost thawing properties can be further improved.

In some embodiments, the first inorganic nanoparticles can be formed from a group of small particles and a group of large particles. In this case, the average particle diameter of the group of small particles can be selected from the range of 2 nm or greater, 3 nm or greater, or 5 nm or greater, but 200 nm or less, 150 nm or less, 120 nm or less, or 100 nm or less. The average particle diameter of the group of large particles can be selected from the range of 60 nm or greater, 65 nm or greater, 70 nm or grater, or 75 nm or greater, but 400 nm or less, 350 nm or less, 300 nm or less, or 200 nm or less. Note that, in the case where each average particle diameter of the two types of inorganic nanoparticles is in the range of 60 nm to 200 nm, which is a range where the ranges of the group of small particles and the group of large particles overlap each other, for example, in the case of a silica sol having the average particle diameter of 60 nm and a silica sol having the average particle diameter of 100 nm, the silica sol having the average particle diameter of 60 nm is classified as the group of small particles and the silica sol having the average particle diameter of 100 nm is classified as the group of large particles.

In the case where the inorganic nanoparticles are highly filled in the frost prevention layer, use of a mixture of inorganic nanoparticles having at least two different inorganic nanoparticle diameter distributions is advantageous. Because the particle diameter distribution of a mixture containing such groups of inorganic nanoparticles exhibit multimodal peaks of bi- or higher-modality, and thus it is possible to distinguish how many types of groups of particles have been used based on the number of peaks.

In some embodiments, a ratio of the average particle diameter of the inorganic nanoparticles of the group of small particles to the average particle diameter of the inorganic nanoparticles of the group of large particles is in a range of 2:1 to 200:1, and in some embodiments, the ratio is in a range from 2.5:1 to 100:1 or from 2.5:1 to 25:1. Examples of a combination of peaks exhibited in the particle diameter distribution of the mixture of the inorganic nanoparticles include 5 nm/190 nm, 5 nm/75 nm, 20 nm/190 nm, 5 nm/20 nm, 20 nm/75 nm, 75 nm/190 nm, or 5 nm/20 nm/190 nm. Use of a mixture containing groups of inorganic nanoparticles having different sizes can highly fill the inorganic nanoparticles in the frost prevention layer, and thus, for example, durability, hardness, and scratch resistance of the frost prevention layer can be further enhanced.

The mass ratio (%) of the group of small particles and the group of large particles can be selected based on the particle diameter to be used or the combination of particle diameters to be used. The preferred mass ratio can be selected by using a software available under the trade name of “CALVOLD 2” based on the particle diameter to be used or the combination of particle diameters to be used and, for example, can be selected based on simulation of the mass ratio of the group of small particles to the group of large particles with regard to the combination of the particle diameters (group of small particles/group of large particles) and the filling ratio (also see “Verification of a Model for Estimating the Void Fraction in a Three-Component Randomly Packed Bed”, M. Suzuki and T. Oshima: Powder Technol., 43, 147-153 (1985)).

For example, by selecting the type, amount, size, and blending ratio of the first inorganic nanoparticles, the performances, such as frost prevention properties, frost thawing properties, transparency, durability, scratch resistance, hardness, hydrophilicity, and surface roughness, can be adjusted.

In some embodiments, use of inorganic nanoparticles having ultraviolet light-shielding ability as the first inorganic nanoparticles, light resistance can be also imparted in addition to the frost prevention properties and the frost thawing properties, and thus durability of the frost prevention layer can be further enhanced. Taking the balance of frost prevention properties, frost thawing properties, and light resistance into consideration, combined use of silica and inorganic nanoparticles having ultraviolet light-shielding ability (e.g. at least one type selected from titanium oxide or zinc oxide) as the first inorganic nanoparticles is preferred.

Because typical organic ultraviolet absorbing agents are hydrophobic, it is difficult to blend in a coating agent for frost prevention containing a hydrophilic binder or hydrophilic monomer or oligomer. On the other hand, because inorganic nanoparticles, such as zinc oxide and titanium oxide, are hydrophilic compared to organic ultraviolet absorbing agents, the inorganic nanoparticles can be blended into the coating agent for frost prevention of the present embodiment. Because the inorganic nanoparticles having ultraviolet light-shielding ability are inorganic materials and have excellent durability, light resistance can be maintained for a longer term compared to the case of an organic ultraviolet absorbing agents.

For example, when the surfaces of the inorganic nanoparticles having ultraviolet light-shielding ability are subjected to coating treatment by silicon oxide, hydrophilicity is enhanced and dispersibility in the coating agent for frost prevention is enhanced, and thus a frost prevention layer having superior frost prevention properties, frost thawing properties, light resistance, and transparency can be provided.

The frost prevention layer can be applied to one face or both face of a substrate. The thickness of the frost prevention layer is not particularly limited and, for example, may be 0.1 μm or greater, 0.5 μm or greater, or 1 μm or greater. The upper limit of the thickness is not particularly limited and, for example, may be 20 μm or less, 15 μm or less, or 10 μm or less.

The frost prevention layer may contain one or a combination of two or more optional components, such as silane coupling agents, flame retardants, antioxidants, antistatic agents, light stabilizers, thermal stabilizers, dispersing agents, surfactants, leveling agents, catalysts, pigments, and dyes, in the range that does not impair the effect of the present embodiment.

As the silane coupling agent (may be also referred to as “first silane coupling agent”), for example, a hydrophilic silane coupling agent, such as an amino-modified alkoxysilane, an epoxy-modified alkoxysilane such as a glycidyl-modified alkoxysilane, a polyether-modified alkoxysilane, or a zwitterion alkoxysilane, can be used. When the silane coupling agent is blended in the frost prevention layer, the inorganic nanoparticles and the hydrophilic binder can be bonded, and thus falling off of the inorganic nanoparticles from the frost prevention layer can be prevented. Use of the silane coupling agent is also useful to enhance interlaminar adhesion between the substrate and the frost prevention layer in the case where an inorganic substrate, such as glass, is employed. For example, a silane coupling agent having, for example, a vinyl group or a (meth)acryl group can be also used as a hydrophilic binder. As the amount of the silane coupling agent, 5 mass % or greater, 10 mass % or greater, or 15 mass % or greater, but 25 mass % or less, 23 mass % or less, or 20 mass % or less, relative to the total weight (dry coating amount) of the frost prevention layer or the total weight (solid content) of the coating agent for frost prevention can be employed.

As the amount of the surfactant, 1.0 mass % or less, 0.5 mass % or less, or 0.01 mass % or less, relative to the total weight (dry coating amount) of the frost prevention layer or the total weight (solid content) of the coating agent for frost prevention can be employed. However, the frost prevention layer of the present embodiment can exhibit frost prevention properties without blending of a surfactant. Furthermore, a surfactant may reduce transparency and scratch resistance of the frost prevention layer by bleeding on the frost prevention layer surface, and thus blending of no surfactant is advantageous.

In some embodiments, the frost prevention layer of the laminate for frost prevention can highly fill up the first inorganic nanoparticles, such as unmodified inorganic nanoparticles, without making them coarse, and achieves, for example, excellent surface hardness, scratch resistance, and transparency in addition to frost prevention properties and frost thawing properties.

The surface hardness of the laminate for frost prevention can be evaluated by, for example, pencil hardness stipulated in JIS K 5600-5-4. For example, in the case where a laminate for frost prevention, in which a frost prevention layer having the thickness of 1.5 μm has been applied to one face of a PET film substrate, is used as a sample, the pencil hardness determined by fixing the sample on a glass plate and scratching the surface at a rate of 600 mm/min under the condition where a load of 750 g is applied at the tip of the lead of the pencil may be 4B or greater, 2B or greater, or H or greater but 4H or less, 3H or less, or 2H or less.

The scratch resistance of the laminate for frost prevention can be evaluated by, for example, steel wool abrasion resistance test. In the test, for example, the evaluation can be performed by using a steel wool abrasion resistance tester (Rubbing Tester IMC-157C, available from Imoto Machinery Co., Ltd.) and 27 mm square #0000 steel wool, abrading a surface of a frost prevention layer of a laminate for frost prevention for 10 times (cycles) at a load of 350 g, 85 mm strokes, and a rate of 60 cycles/min, and evaluating by Ahaze value (haze value after abrasion test—initial haze value) based on the haze measurement described below.

In the case where a laminate for frost prevention, in which a frost prevention layer having the thickness of 1.5 μm has been applied to one face of a typical transparent optical film substrate, such as COSMOSHINE (trademark) A4100 having the thickness of 50 μm (available from Toyobo Co., Ltd.), is used as a sample, the Ahaze value may be from −0.20% to 0.20%, from −0.15% to 0.15%, or from −0.10% to 0.10%.

The transparency of the laminate for frost prevention can be evaluated by, for example, a haze or total light transmittance test. The haze and the total light transmittance can be measured by JIS K 7136 (2000) and JIS K 7361-1 (1997), respectively, by using NDH-5000W (available from Nippon Denshoku Industries Co., Ltd.).

In the case where a laminate for frost prevention, in which a frost prevention layer having the thickness of 1.5 μm has been applied to one face of a typical transparent optical film substrate, such as COSMOSHINE (trademark) A4100 having the thickness of 50 μm (available from Toyobo Co., Ltd.), is used as a sample, the initial haze value may be 5.0% or less, 3.0% or less, or 1.0% or less. The lower limit of the initial haze value is not particularly limited and, for example, may be greater than 0%, 0.10% or greater, or 0.20% or greater. The total light transmittance may be 85.0% or greater, 87.0% or greater, or 89.0% or greater. The upper limit of the total light transmittance is not particularly limited and, for example, may be 98.0% or less, 96.0% or less, or 94.0% or less.

In some embodiments, in the laminate for frost prevention of the present embodiment, to enhance the adhesion between the frost prevention layer and the substrate, surface treatment may be optionally performed or a primer layer may be optionally applied onto the substrate surface.

Surface treatments are known in the art, and examples of the surface treatment include plasma treatment, corona discharge treatment, flame treatment, electron beam irradiation treatment, roughening treatment, ozone treatment, and chemical oxidizing treatment by using chromic acid or sulfuric acid.

Because the coating agent for frost prevention of the present embodiment is hydrophilic, in the case of employing a water-repellent surface, such as a substrate having a surface with a water contact angle of 80 degrees or greater or 90 degrees or greater, application of a primer layer having a water contact angle of 10 degrees or greater, 15 degrees or greater, or 20 degrees or greater, but 60 degrees or less, 50 degrees or less, or 40 degrees or less, is preferred taking coatability of the coating agent for frost prevention into consideration. Such a primer layer can be formed by using, for example, a coating agent for primer, and the coating agent contains inorganic nanoparticles (may be also referred to as “second inorganic nanoparticles”) and a silane coupling agent (may be also referred to as “second silane coupling agent”).

As the second inorganic nanoparticles and the second silane coupling agent used in the primer layer, same substances for the first inorganic nanoparticles and the first silane coupling agent described above can be used, respectively. From the perspectives of coatability to the substrate as well as adhesion for the substrate and the frost prevention layer, it is advantageous for the second inorganic nanoparticles to be at least one type of particles selected from the group consisting of silica, titanium oxide, zinc oxide, silica-coated titanium oxide, and silica-coated zinc oxide. Furthermore, in the case where light resistance is further taken into consideration, a combined use of silica and inorganic nanoparticles having ultraviolet light-shielding ability (e.g. at least one type selected from the group consisting of titanium oxide, zinc oxide, silica-coated titanium oxide, and silica-coated zinc oxide) is advantageous. As the second silane coupling agent, a silane coupling agent having, for example, a vinyl group or a (meth)acryl group, which can also function as a binder, is advantageous from the perspectives of coatability to the substrate as well as adhesion for the substrate and the frost prevention layer.

It is advantageous for the content of the second inorganic nanoparticles in the primer layer to be less than the content of the first inorganic nanoparticles in the frost prevention layer from the perspectives of coatability to the substrate as well as adhesion for the substrate and the frost prevention layer.

The primer layer can be formed by coating a coating agent for primer containing inorganic nanoparticles and a silane coupling agent onto a substrate by a known method in the art, such as bar coating, dip coating, spin coating, capillary coating, spray coating, gravure coating, and screen printing, and drying.

The thickness of the primer layer is not particularly limited and, for example, may be 0.1 μm or greater, or 0.5 μm or greater, but 20 μm or less, 10 μm or less, or 5 μm or less.

In some embodiments, the laminate for frost prevention of the present embodiment may optionally have an additional layer, such as a coloring layer, a decorative layer, a conductive layer, an adhesive layer, or a pressure-sensitive adhesive layer, for example, between the frost prevention layer and the substrate or on the substrate face which is opposite side of the frost prevention layer.

The laminate for frost prevention of the present embodiment may be, for example, a cut-sheet article, a rolled body wound in a roll shape, or a three-dimensionally shaped article.

The production method of the laminate for frost prevention is not particularly limited and, for example, the laminate for frost prevention can be produced by a process of forming an uncured frost prevention layer by coating a coating agent for frost prevention on a substrate that may optionally have a primer layer and drying, and a process of curing the uncured frost prevention layer.

The coating agent for frost prevention of the present embodiment may contain various materials that can be used in the frost prevention layer described above and is a coating agent at least containing first inorganic nanoparticles and at least one selected from the group consisting of hydrophilic binders, hydrophilic curable monomers, and hydrophilic curable oligomers, and the frost prevention layer is formed by the coating agent for frost prevention exhibiting a water contact angle of 19.0 degrees or less.

In some embodiments, the coating agent for frost prevention may further contain water and an organic solvent that is compatible with water. Herein, “compatible with water” means that the water and the organic solvent are uniformly mixed without being separated from each other. The solubility parameter (SP) value of the organic solvent that is compatible with water is, for example, 9.3 or greater, or 10.2 or greater, but less than 23.4.

In some embodiments, the coating agent for frost prevention can be obtained by, for example, mixing a sol of water-dispersible inorganic nanoparticles with a hydrophilic curable monomer together with a reaction initiator in a solvent, and optionally adding a solvent to adjust the solid content to a desired solid content. As the reaction initiator, for example, a known photopolymerization initiator or thermal polymerization initiator described above can be used.

For example, unmodified water-dispersible inorganic nanoparticles are dispersed in the sol due to electrostatic repulsion between the particles. When such inorganic nanoparticles are blended in a coating agent for frost prevention containing at least one selected from the group consisting of hydrophilic binders, hydrophilic curable monomers, and hydrophilic curable oligomers, the inorganic nanoparticles aggregate and the particle diameter is increased, and thus properties, such as transparency, of the resulting frost prevention layer may be deteriorated. In a production method of one embodiment, selection of a solvent to be used at the time of adjusting the coating agent for frost prevention enables dispersion of the unmodified water-dispersible inorganic nanoparticles in the coating agent for frost prevention.

As the solvent, a mixed solvent of water and an organic solvent that is compatible with water can be used. As the amount of water in the mixed solvent, 30 mass % or greater, 35 mass % or greater, 40 mass % or greater, 50 mass % or greater, or 60 mass % or greater, relative to the total weight of the coating agent for frost prevention can be employed.

As the organic solvent that is compatible with water, for example, at least one selected from, for example, methanol, ethanol, isopropanol, or 1-methoxy-2-propanol can be used. Among these, use of an organic solvent in which 1-methoxy-2-propanol and at least one of methanol, ethanol, or isopropanol are mixed is preferred.

As the mass ratio of water to the organic solvent that is compatible with water, for example, 30:70, 35:65, 40:60, 50:50, or 60:40 can be employed. In the organic solvent that is compatible with water, the mass ratio of the 1-methoxy-2-propanol to at least one of the methanol, ethanol, or isopropanol may be, for example, 95:5, 90:10, 80:20, 70:30, 60:40, 50:50, or 40:60.

Examples of the technique to apply the coating agent for frost prevention on the surface of the substrate include bar coating, dip coating, spin coating, capillary coating, spray coating, gravure coating, and screen printing, but the technique is not limited to these.

The frost prevention layer applied to the substrate is dried if needed, and can be cured by a polymerization method known in the art, such as a photopolymerization method by using ultraviolet light or an electron beam or a thermal polymerization method. The laminate for frost prevention of the present embodiment can be obtained by forming the frost prevention layer on the substrate as described above.

The laminate for frost prevention of the present embodiment has excellent frost prevention properties and is advantageously used for uses under environments where frost tends to form (e.g. environment at a temperature of −10 to 0° C. and a humidity of 40% or greater, or 50% or greater), such as heat exchangers that are mounted on, for example, air conditioners; traffic lights (e.g., traffic lights using LEDs); windows, bodies, or light covers (e.g., light covers for LEDs) of vehicles (e.g., cars, ships, trains, and aircraft); window glass, sash windows, doors, doorknobs, or exterior materials of buildings; home electrical appliances, such as refrigerators; glasses or goggles; measurement devices or observation devices; solar panels; and structural components for wind power generators, but not limited to these.

Among these, the laminate for frost prevention of the present embodiment has excellent performances to reduce or prevent growth of frost and thus is advantageously used as a structural component for a heat exchanger, in particular, as a fin for a heat exchanger that is typically used in a narrow space.

In the case where the laminate for frost prevention is used as a fin for a heat exchanger, clogging between fins involving frost growth can be prevented, and thus decrease in heat exchange efficiency can be reduced or prevented. The laminate for frost prevention of the present embodiment is particularly advantageously used as a structural component for a heat exchanger for an electric car or a hybrid car, with which utilization of waste heat from an engine is difficult and to which an electric motor is mounted.

### EXAMPLES

Specific embodiments of the present disclosure are exemplified in the following examples, but the present invention is not limited to these embodiments. All parts and percentages are based on mass, unless otherwise stated.

Various properties were evaluated according to the following methods.

### Frost Prevention Properties: Frost Formation Test

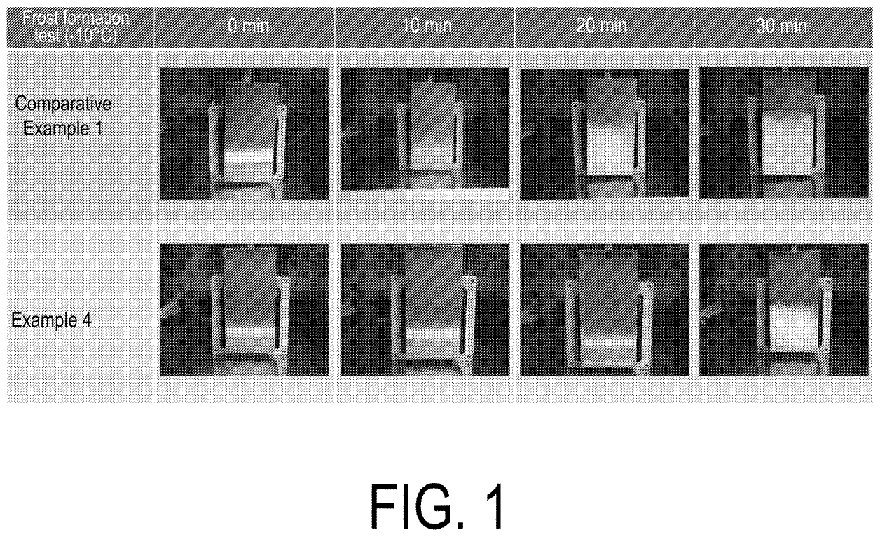

A test sample was applied to a Peltier device (a black square device on the back of the test sample in FIG. 1) through a heat conductive adhesive sheet having a thermal conductivity of 2.0 W/mK and a thickness of 1 mm (3M (trademark) Hypersoft Heat Dissipation Sheet, available from 3M Japan Limited) and placed in an oven. The oven was configured to maintain the ambient temperature at 10° C. and allows a current of air having the humidity of 53% to flow in the oven at a speed of 1.0 m/sec.

The Peltier device was set to allow the temperature of the test sample surface to be -10° C., and the state of frost formation on the test sample surface was visually observed every 10 minutes. The case where whitening of the test sample surface was visually confirmed was judged as frost formation and growth occurred. The results are shown in FIG. 1 and Table 3. Note that the time in

Table 3 is the time at which the frost formation and growth were obviously occurred, and it can be said that the case where the time took was longer suppressed the frost growth better. For example, in the case of FIG. 1, the time at which the frost was obviously formed was 20 minutes in Comparative Example and 30 minutes in Example 4, and thus it can be said that Example 4 suppressed the frost growth better.

### Frost Thawing Properties: Frost Thawing Test

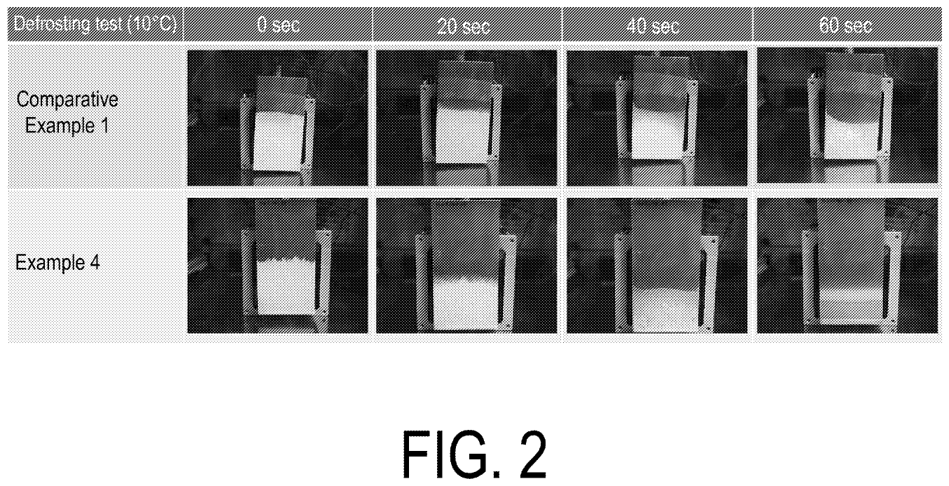

After the frost formation test described above was performed for 60 minutes, only the driving of the Peltier device was stopped, and the thawing state of the frost on the test sample surface was visually observed every 20 seconds. The case where return of the color of the test sample surface to the original color of the test sample surface was visually confirmed was judged as frost thawing occurred. The results are shown in FIG. 2 and Table 3. Note that the time in Table 3 is the time at which the frost thawing obviously occurred, and it can be said that the case where the time took was shorter exhibited superior frost thawing properties. For example, in the case of FIG. 2, while the frost thawing obviously occurred at 60 seconds in Example 4, obvious frost thawing was not confirmed at 60 seconds in Comparative Example 4, and thus Example 4 exhibited superior frost thawing properties. The case where obvious frost thawing was not confirmed even at 60 seconds was described as “>60” in Table 2.

### Arithmetic Average Surface Roughness Ra

The arithmetic average surface roughness Ra of the coating layer surface of the laminate for frost prevention was calculated in accordance with JIS B 0601 by using an atomic force microscope (Cypher (trade name) AFM, available from Asylum Technology) under the following conditions.

Scan speed (probe movement speed):

18 μm/sec (when a 3 μm×3 μm image was taken)

6 μm/sec (when a 1 μm×1 μm image was taken)

Resolution: 256 pixel×256 pixel

Measurement mode: Tapping mode

Probe: AC240TS (available from Olympus Corporation; spring constant: 2 nN/nm)

Amplitude value of cantilever: 1 V

Set point value (contact pressure): 0.8 V

Gain value: 30.0

The observation was performed for two area regions, which were 1 μm×1 μm and 3 μm×3 μm. The results are shown in Table 3 and FIG. 3. The Ra value in Table 3 is the average value for entirety of each region.

### Water Contact Angle

The water contact angle of the coating layer surface was measured by a sessile drop method using a contact angle meter (available under the trade name of “DropMaster Face” from Kyowa Interface Science Co., Ltd.). On a surface of the test sample, 2 μL of water was added dropwise, and then the water contact angle was measured based on an optical microscope image. The value of the water contact angle was calculated as an average of five measurements. The results are shown in Table 3.

### Adhesion

The adhesive performance between the substrate and the coating layer is evaluated as a cross-cut method in accordance with JIS K 5600. Here, a 5×5 grid having a grid spacing of 1 mm and Cellotape (trade name) CT-24 (available from Nichiban Co., Ltd.) were employed. The case where no peeling occurred in the coating layer was evaluated as “Good”, and the case where peeling occurred in the coating layer was evaluated as “Poor”, and the results are shown in Table 3.

The materials used in the present examples are shown in Table 1.

TABLE 1

| Trade name, model | | |
|---|---|---|
| number or abbreviation | Description | Provider |
| NALCO (trademark) 2329K | Unmodified SiO₂ sol; average particle diameter: 75 nm; | NALCO (USA) |
| | solid content: 41.0 mass % | |
| NALCO (trademark) 2327 | Unmodified SiO₂ sol; average particle diameter: 20 nm; | NALCO (USA) |
| | solid content: 43.7 mass % | |
| NALCO (trademark) 2326 | Unmodified SiO₂ sol; average particle diameter: 5 nm; | NALCO (USA) |
| | solid content: 20.8 mass % | |
| IPA ST | Unmodified SiO₂ sol in 2-propanol; average particle | Nissan Chemical Corporation (Chuo-ku, |
| | diameter: 12 nm; solid content: 30.0 mass % | Tokyo, Japan) |
| EBECRYL (trademark) 11 | Hydrophilic curable monomer: polyethylene glycol 600 diacrylate | Daicel-Allnex Ltd. (Chuo-ku, Tokyo, Japan) |
| A-1170 | Silane coupling agent: secondary aminofunctional bis-silane | Momentive (US) |
| SAC | Silane coupling agent: | 3M Company (US) |
| | CH₂═CH—(CO)O—(CH₂)₂—O(CO)—NH—(CH₂)—Si(OCH₃)₃ | |
| SILQUEST (trademark) A-174 | Silane coupling agent: 3-methacryloxypropyltrimethoxysilane | Alfa Aesar |
| Irgacure (trademark) 2959 | Photopolymerization initiator: 1-[4-(2-hydroxyethoxy)-phenyl]- | BASF Japan Ltd. (Minato-ku, Tokyo, Japan) |
| | 2-hydroxy-2-methyl-1-propan-1-one | |
| BYK UV3535 | Leveling agent: silicone-free acrylic group-containing modified | BYK Japan KK (Shinjuku-ku, Tokyo, Japan) |
| | polyether | |
| PROSTAB (trademark) | 4-hydroxy-2,2,6,6-tetramethylpiperidine-1-oxyl | BASF Japan Ltd. (Minato-ku, Tokyo, Japan) |
| TEGO (trademark) Rad 2250 | Water-repellent additive: organic modified silicone acrylate | Evonik (Germany) |
| KY1203 | Water-repellent additive: fluorine-containing acrylic compound | Shin-Etsu Chemical Co., Ltd (Chiyoda-ku, |
| | | Tokyo, Japan) |
| MIPA | 1-methoxy-2-propanol | FUJIFILM Wako Pure Chemical Corporation |
| | | (Chuo-ku, Osaka-shi, Japan) |
| EtOH | Ethanol | FUJIFILM Wako Pure Chemical Corporation |
| | | (Chuo-ku, Osaka-shi, Japan) |
| IPA | 2-Propanol | FUJIFILM Wako Pure Chemical Corporation |
| | | (Chuo-ku, Osaka-shi, Japan) |
| Aluminum Substrate | Aluminum substrate having size of 100 mm length × 50 mm | U-kou KK (Kawasaki-shi, Kanagawa-ken, Japan) |
| | width × 1.0 mm thickness in accordance with JIS H 4000 | |

Preparation of Aluminum Substrate including Primer Layer

In a mixture of 488 g of IPA and 2.0 g of A-1170 in a glass vial, 10.0 g of IPA ST was added and agitated at room temperature for 10 minutes to prepare a coating agent for primer. An aluminum substrate was hung from a head part of a dip coater and fixed, and then the aluminum substrate was dipped in the coating agent for primer. After the aluminum substrate was dipped for 30 seconds, the aluminum substrate was pulled up at a moving-up rate of 3.00 mm/sec. The obtained aluminum substrate was allowed to stand in an oven at 150° C. for 5 minutes to prepare an aluminum substrate including a primer layer.

### Preparation of SAC

SAC was prepared by the method described in Preparative Example 7 described in US 2015/0,203,708 (Klun et al.). Specifically, in a 500 mL round bottom flask equipped with an overhead stirrer, 140.52 g (0.684 mol; weight average molecular weight: 205.28) of 3-trimethoxysilyl propyl isocyanate and 0.22 g of dibutyl tin dilaurate (DBTDL) were added and heated at 55° C. Using a dropping funnel, 79.48 g (0.684 mol; weight average molecular weight: 116.12) of hydroxyethyl acrylate was added over approximately 1 hour. In the total of approximately 4 hours, the product was isolated and placed in a vial. Note that the weight average molecular weight was determined by gel permeation chromatography (GPC) using standard polystyrene.

### Preparation of Modified Silica Sol

In a mixture of 400 g of NALCO (trade name) 2327 and 450 g of MIPA in a glass vial, 25.25 g of SILQUEST (trade name) A-174 and 0.5 g of PROSTAB (trade name) were added and agitated at room temperature for 10 minutes. The glass vial was tightly sealed and allowed to stand in an oven at 80° C. for 16 hours. From the obtained solution, water was removed by using a rotatory evaporator at 60° C. until the solid content of the solution became approximately 45 mass %. In the obtained solution, 200 g of MIPA was placed, and then the rest of the water was removed by using a rotatory evaporator at 60° C. The latter step was repeated twice to further remove the water from the solution. Finally, MIPA was added to adjust the concentration of the entire SiO₂ nanoparticles to 45.59 mass %, and thus a SiO₂ sol containing surface-modified SiO₂ nanoparticles having the average particle diameter of 20 nm (hereinafter, referred to as “modified silica sol”) was obtained.

### Preparation of Coating Agent 1

3.903 g of NALCO (trade name) 2329K, 0.392 g of EBECRYL (trade name) 11, and 0.008 g of SAC were mixed. To the mixture, 0.06 g of Irgacure 2959 as a photopolymerization initiator and 0.004 g of BYK UV3535 as a leveling agent were added. Then, 1.600 g of EtOH, 2.400 g of MIPA, and 1.697 g of distilled water were added to the mixture to prepare a coating agent 1.

### Preparation of Coating Agents 2 to 5

Each of coating agents 2 to 5 was prepared in the same manner as for the coating agent 1 except for employing blending proportions described in Table 2 below. Note that all the blended amounts in Table 2 are in terms of gram.

### Preparation of Coating Agent 6

3.510 g of modified silica sol, 0.392 g of EBECRYL (trade name) 11, and 0.008 g of SAC were mixed. To the mixture, 0.06 g of Irgacure 2959 as a photopolymerization initiator was added. Then, 1.600 g of EtOH, 2.400 g of MIPA, and 0.822 g of distilled water were added to the mixture to prepare a coating agent 6.

### Preparation of Coating Agent 7

3.510 g of modified silica sol, 0.392 g of EBECRYL (trade name) 11, and 0.008 g of SAC were mixed. To the mixture, 0.06 g of Irgacure 2959 as a photopolymerization initiator and 0.008 g of TEGO (trade name) Rad 2250 as a water-repellent additive were added. Then, 1.600 g of EtOH, 2.400 g of MIPA, and 1.198 g of distilled water were added to the mixture to prepare a coating agent 7.

### Preparation of Coating Agent 8

3.510 g of modified silica sol, 0.392 g of EBECRYL (trade name) 11, and 0.008 g of SAC were mixed. To the mixture, 0.06 g of Irgacure 2959 as a photopolymerization initiator and 0.008 g of KY 1203 as a water-repellent additive were added. Then, 1.600 g of EtOH, 2.400 g of MIPA, and 1.780 g of distilled water were added to the mixture to prepare a coating agent 8.

TABLE 2

| | | Coating agent (g) | | | | | | | |
|---|---|---|---|---|---|---|---|---|---|
| Composition | | 1 | 2 | 3 | 4 | 5 | 6 | 7 | 8 |
| Inorganic | NALCO (trademark) 2329K (average particle | 3.903 | — | — | 3.006 | 2.537 | — | — | — |
| nanoparticles | diameter: 75 run; solid content: 41.0 mass %) | | | | | | | | |
| | NALCO (trademark) 2327 (average particle | — | 3.666 | — | — | 1.283 | — | — | — |
| | diameter: 20 nm; solid content: 43.7 mass %) | | | | | | | | |
| | NALCO (trademark) 2326 (average particle | — | — | 3.854 | 1.773 | — | — | — | — |
| | diameter: 5 nm; solid content: 20.8 mass %) | | | | | | | | |
| | Modified silica sol (average particle | — | — | — | — | — | 3.510 | 3.510 | 3.510 |
| | diameter: 20 nm; solid content: 45.59 mass %) | | | | | | | | |
| Hydrophilic curable monomer | EBECRYL (trademark) 11 | 0.392 | 0.392 | 0.196 | 0.392 | 0.392 | 0.392 | 0.392 | 0.392 |
| Silane coupling agent | SAC | 0.008 | 0.008 | 0.004 | 0.008 | 0.008 | 0.008 | 0.008 | 0.008 |
| Leveling Agent | BYK UV3535 | 0.004 | 0.004 | 0.002 | 0.004 | 0.004 | — | — | — |
| Photopolymerization initiator | Irgacure (trademark) 2959 | 0.060 | 0.060 | 0.003 | 0.060 | 0.060 | 0.06 | 0.06 | 0.06 |
| Water-repellent | TEGO (trademark) Rad 2250 | — | — | — | — | — | — | 0.008 | — |
| additive | | | | | | | | | |
| | KY1203 | — | — | — | — | — | — | — | 0.008 |
| Diluent | IPA | 1.600 | 1.600 | 1.800 | 1.600 | 1.600 | 1.600 | 1.600 | 1.600 |
| | MIPA | 2.400 | 2.400 | 2.700 | 2.400 | 2.400 | 2.400 | 2.400 | 2.400 |
| | Distilled water | 1.697 | 1.934 | 1.446 | 0.822 | 1.780 | 0.822 | 1.198 | 1.780 |

### Example 1

The coating agent 1 was coated on the primer layer of the aluminum substrate including the primer layer by using a Meyer rod #8 and dried at 60° C. in air atmosphere for 5 minutes. The substrate to which the coating layer was applied was then passed through an ultraviolet light irradiation device (H-bulb (model: DRS), available from Fusion UV System Inc.) twice in a nitrogen atmosphere to cure the coating layer. At this time, the coating layer was irradiated with ultraviolet light (UV-A) under the condition where the illuminance was 700 mW/cm² and the integrated light quantity of 900 mJ/cm².

As described above, a laminate including a coating layer having a thickness of 1.0 μm was prepared.

### Example 2 to Example 4

Each of laminates of Example 2 to Example 4 was prepared in the same manner as in Example 1 except for using a coating agent shown in Table 3.

### Comparative Example 1

An aluminum substrate having a size of 100 mm length×50 mm width×1.0 mm thickness in accordance with JIS H 4000 was used.

### Comparative Example 2

A laminate of Comparative Example 2 was prepared in the same manner as in Example 1 except for using the coating agent 3 and a Meyer rod #20.

### Comparative Examples 3 to 5

Each of laminates of Comparative Examples 3 to 5 was prepared in the same manner as in Example 1 except for using a coating agent shown in Table 3.

The evaluation results for Examples 1 to 4 and Comparative Examples 1 to 5 are shown in Table 3.

TABLE 3

| | | | Compar- | | | Compar- | | | Compar- | Compar- | Compar- |
|---|---|---|---|---|---|---|---|---|---|---|---|
| | | | ative | Example | Example | ative | Example | Example | ative | ative | ative |
| | | | Example 1 | 1 | 2 | Example 2 | 3 | 4 | Example 3 | Example 4 | Example 5 |
| Coating agent | | | — | 1 | 2 | 3 | 4 | 5 | 6 | 7 | 8 |
| Evaluation | Frost | Frost | 20 | 50 | 30 | 10 | 30 | 30 | 10 | 10 | 10 |
| items | prevention | formation | | | | | | | | | |
| | properties | time (min) | | | | | | | | | |
| | Frost | Frost | >60 | 40 | >60 | >60 | >60 | 60 | >60 | >60 | >60 |
| | thawing | thawing | | | | | | | | | |
| | properties | time (sec) | | | | | | | | | |
| | Arithmetic | 3 × 3 μm² | — | 4.06 | 1.72 | 0.60 | 5.49 | 4.32 | — | — | — |
| | average | 1 × 1 μm² | — | 3.62 | 1.89 | 0.65 | 5.61 | 4.33 | — | — | — |
| | surface | | | | | | | | | | |
| | roughness | | | | | | | | | | |
| | Ra (nm) | | | | | | | | | | |
| | Hydro- | Water contact | 93.10 | 8.00 | 18.40 | 19.10 | 16.10 | 8.80 | 63.90 | 65.60 | 74.20 |
| | philicity | angle (degree) | | | | | | | | | |

| | | | | | | | | | |
|---|---|---|---|---|---|---|---|---|---|
| Adhesion | — | Good | Good | Good | Good | Good | Good | Good | Good |

It will be apparent to those skilled in the art that various modifications can be made to the embodiments and the examples described above without departing from the principles of the present invention. In addition, it will be apparent to those skilled in the art that various improvements and modifications of the present invention can be carried out without departing from the gist and the scope of the present invention.

1. A laminate for frost prevention comprising:
a substrate, and
a frost prevention layer containing first inorganic nanoparticles and a hydrophilic binder and exhibiting a water contact angle of 19.0 degrees or less,
wherein
the first inorganic nanoparticles are at least one type of particles selected from the group consisting of silica, alumina, titanium oxide, zinc oxide, zirconium oxide, tin-doped indium oxide, and antimony-doped tin oxide;
75 mass % or greater of the first inorganic nanoparticles are contained relative to a total weight of the frost prevention layer;
an average particle diameter of the first inorganic nanoparticles is 15 nm or greater; and
an arithmetic average surface roughness Ra of a surface of the frost prevention layer is 1.0 nm or greater.

2. (canceled)

3. (canceled)

4. The laminate according to claim 1, wherein an arithmetic average surface roughness Ra of a surface of the frost prevention layer is 30 nm or less.

5. The laminate according to claim 1, wherein the hydrophilic binder is at least one type selected from the group consisting of polyethylene glycols, hydroxy group-containing resins, and hydrophilic (meth)acrylic resins.

6. (canceled)

7. The laminate according to claim 1, wherein the frost prevention layer further contains a first silane coupling agent.

8. The laminate according to claim 1, further comprising a primer layer containing second inorganic nanoparticles and a second silane coupling agent, between the substrate and the frost prevention layer.

9. The laminate according to claim 8, wherein a content of the second inorganic nanoparticles in the primer layer is less than the content of the first inorganic nanoparticles in the frost prevention layer.

10. The laminate according to claim 8, wherein the second inorganic nanoparticles are at least one type of particles selected from the group consisting of silica, titanium oxide, zinc oxide, silica-coated titanium oxide, and silica-coated zinc oxide.

11. The laminate according to claim 1, wherein the substrate contains aluminum.

12. A heat exchanger comprising the laminate described claim 1.

13. (canceled)
